(19) United States
(12) Patent Application Publication
(10) Pub. No.: US 2012/0331521 A1
(43) Pub. Date: Dec. 27, 2012

(54) SYSTEM AND METHOD FOR APPLICATION CENTRIC CLOUD MANAGEMENT

(75) Inventor: Sariya ANSARI, Lucknow (IN)

(73) Assignee: SAMSUNG ELECTRONICS CO., LTD., Suwon-si (KR)

(21) Appl. No.: 13/534,734

(22) Filed: Jun. 27, 2012

(30) Foreign Application Priority Data
Jun. 27, 2011 (IN) 2164/CHE/2011
Jun. 25, 2012 (KR) 10-2012-0068144

(51) Int. Cl. G06F 15/16; G06F 21/20

(52) U.S. Cl. 726/3

(57) ABSTRACT

An application-based cloud management system and method are provided. The cloud management method comprises authenticating a user to access a cloud network, determining a user behavior of the authenticated user using one or more metadata stored in a cache memory, loading resources related to the user behavior to a virtual machine, and allocating the virtual machine to the authenticated user.

### CROSS-REFERENCE TO RELATED APPLICATIONS

This application claims priorities from Korean Patent Application No. 10-2012-0068144, filed on Jun. 25, 2012, in the Korean Intellectual Property Office, and Indian Patent Application No. 2164/CHE/2011, filed on Jun. 27, 2011, the disclosures of which are incorporated herein in their entirety by reference.

### FIELD

Methods and apparatuses consistent with the exemplary embodiments relate to a method and a system for providing services, products and event handling to users in a cloud.

### BACKGROUND

Recently, cloud based computing has been widely utilized for rapid and scalable deployment of services. Examples of such services include, but are not limited to, virtual web store, media outlets, e-store, Internet shop, web-shop and other online sites. In the related art, a cloud based architecture provided by a cloud service provider deploys resources that may be hosted by an Internet service provider. The Internet service provider provides connectivity of Internet services to a user Examples of resources include, but are not limited to, one or more processors, operating systems, display devices, one or more storage devices and the like. The resources are coupled to each other to form a virtual machine.

The user may request the virtual machine from a cloud service provider to perform one or more intended tasks. The virtual machine is controlled by a central server for providing the resources to perform the one or more intended tasks by the user. Further, the cloud based architecture includes several virtual machines that may be scaled on demand. Furthermore, the several virtual machines included in the cloud architecture are communicably connected to a user utilizing an Internet Protocol (IP) network.

In the related art, the cloud service provider renders cloud computing services to the user based on factors such as trend analysis and pricing. The cloud service provider charges prices for rendering the cloud computing services based on historical computing trends, resource utilization, economic factors and the like. Further, the cloud service provider maintains a cache region for storing one or more data in the cloud computing architecture. The cache region may include one or more metadata utilized for computing the one or more data stored in the cache. In one example, the cache region may include a shopping cart that includes several products while the user is performing online shopping. The cloud service provider allows the user to add or delete a single product included in the shopping cart. Further, upon completion of the online shopping by the user, the cloud service provider may delete the shopping cart stored in the cache region. However, the cache region does not store a user behavior required for loading the data quickly upon subsequent log-in by the user.

In another example, the cloud service provider provides a license agreement to the user. The license agreement allows the user to access the resources present in the cloud. Further, the license agreement also allows the user to install a software in one or more computing devices as validated in the license agreement. Similarly, license agreements of a plurality of users may be maintained in the cloud to service multiple users simultaneously. Further, the license agreement is independent of a physical location of the user. However, the license agreement does not specify the allocation of resources to the user. Further, the license agreement provided by the cloud service provider currently lacks the provision of allowing discrete pricing for the user.

In yet another example, a monitor and control mechanism allows the user to monitor and control the access of a user's personal data that is maintained in the cloud. Monitoring is performed by an access control list (ACL) provided to the user by the cloud computing architecture. The user may utilize the ACL for either restricting access of the user's personal data, allowing access to the user's personal data, or allowing limited access to the user's personal data. However, the monitor and control mechanism do not provide manipulation of the monitored and controlled data.

In the related art, the cloud computing architecture provides a load-balancing function and a scaling function to the resources present in the cloud. The cloud computing architecture is configured to monitor and allocate resources. A resource record is utilized for maintaining and allocating resources. The cloud computing architecture is configured to receive a request for resources from the user for initializing the virtual machine including the available resources. Further, during non-availability of resources, the cloud computing architecture acquires resources from a reserve resource server. Furthermore, if the resources are unavailable, the cloud computing architecture is configured to acquire resources from an external cloud network. However, the related art cloud computing architecture does not acquire resources prior to the request for resources from the user. Hence a system for providing increased revenue to the cloud service provider and providing increased benefits to the user is desired.

In the light of the foregoing discussion there is a need for a system and a method for an enhanced application centric cloud management that addresses the above mentioned limitations.

### SUMMARY

Exemplary embodiments described herein provide a system and a method for an enhanced application centric cloud management.

A method for managing a cloud according to an exemplary embodiment includes authenticating a user to access a cloud network, determining a user behavior of the authenticated user using one or more metadata stored in a cache memory, loading resources related to the user behavior to a virtual machine, and allocating the virtual machine to the authenticated user.

The determining may include determining a cloud application in association with the authenticated user, determining one or more resources related to a cloud application in association with the user, and determining resources related to a user behavior from among the resources using a cache memory storing the one or more metadata.

The one or more metadata may include information related to at least one of a cloud application most frequently used by the authenticated user and a cloud application most recently used by the authenticated user.

The user behavior may be at least one of a pattern of usage, settings, service of interest, and a cloud application of the authenticated user.

The method may further include classifying sub-components of a cloud application related to the user and setting a refined license with respect to the sub-components, and the loading may load resources related to the user behavior based on a license refined by a user with respect to the categorized sub-components.

The setting may further include generating and displaying a UI to set a refined license with respect to the sub-components.

The method may further include determining whether the resources related to the user behavior are available in the cloud network and, if the resources related to the user behavior are not available in a cloud network, obtaining resources from an external cloud network.

A cloud management system according to an exemplary embodiment includes a cache memory storing one or more metadata and a control unit which, if a user request to access a cloud network is authenticated, determines a user behavior of an authenticated user using the cache memory, loading resources related to the user behavior to a virtual machine, and allocating a virtual machine to the authenticated user.

The control unit may determine a cloud application related to the authenticated user, determine one or more resources related to a cloud application in association with the user, and determine resources related to a user behavior from among the resources using a cache memory storing one or more metadata.

The one or more metadata may include information related to at least one of a cloud application most frequently used by the authenticated user and a cloud application most recently used by the authenticated user.

The user behavior may be at least one of a pattern of usage, settings, service of interest, and a cloud application of the authenticated user.

The method may further include a discrete license refiner which categorizes sub-components of a cloud application related to the user and sets a reference license with respect to the sub-components, and the control unit may load resources related to the user behavior based on a refined license set by the discrete license refiner.

The control unit may generate and display a UI to set a refined license with respect to the sub-components.

The resources may be at least one of a hardware component and a software component required to use a cloud application.

### BRIEF DESCRIPTION OF THE DRAWINGS

The accompanying figure, similar reference numerals may refer to identical or functionally similar elements. These reference numerals are used in the detailed description to illustrate various exemplary embodiments and to explain various aspects and advantages of the present disclosure.

FIG. 1 is a block diagram of an environment in accordance with which various exemplary embodiments can be implemented;

FIG. 2 is a block diagram of a system for an enhanced application centric cloud management in accordance with an exemplary embodiment;

FIG. 3 is a flowchart illustrating a method for an enhanced application centric cloud management in accordance with an exemplary embodiment;

FIG. 4 is a flowchart illustrating a method for determining a user behavior in accordance with an exemplary embodiment;

FIG. 5 is a flowchart illustrating a method for providing license refinement for cloud resources in accordance with an exemplary embodiment;

FIG. 6 is a flowchart illustrating a method for obtaining load balancing for cloud resources in accordance with an exemplary embodiment; and

FIG. 7 is an exemplary illustration for providing discrete pricing of cloud application in accordance with an exemplary embodiment.

### DETAILED DESCRIPTION OF THE EXEMPLARY EMBODIMENTS

It should be observed that the method steps and system components have been represented by symbols in the figure, showing only specific details which are relevant for an understanding of the exemplary embodiments. Further, details may be readily apparent to a person of ordinary skill in the art may not have been disclosed. In the exemplary embodiments, relational terms such as first and second, and the like, may be used to distinguish one entity from another entity, without necessarily implying any actual relationship or order between such entities.

Exemplary embodiments described herein provide a system and a method for an enhanced application centric cloud management.

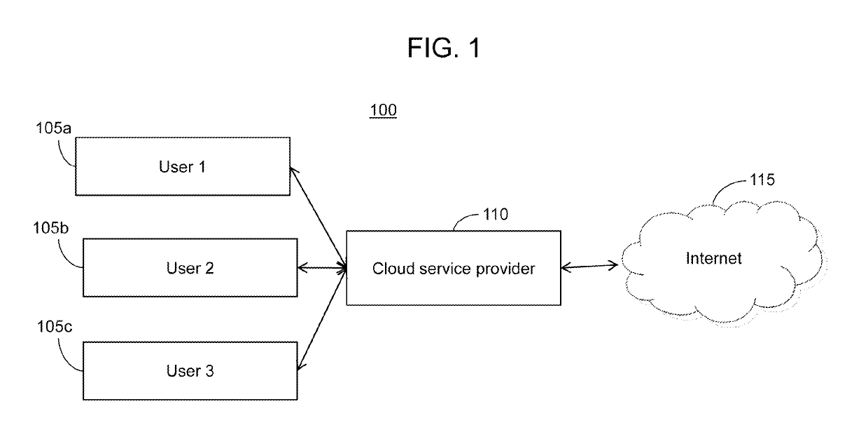

FIG. 1 is a block diagram of an environment 100 in accordance with which various exemplary embodiments may be implemented. The environment 100 includes one or more users such as user 1 105a, user 2 105b and user 3 105c. The environment 100 also includes cloud service provider 110 connected to the Internet 115.

The cloud service provider 110 utilizes the Internet 115 for providing cloud services. The cloud service provider 110 provides resources present in a cloud network to the user. The cloud service provider 110 allocates the resources to the user dynamically.

The cloud service provider 110 utilizes Internet hosting services for providing access to the Internet 115. The cloud service provider 110 also provides access to the Internet 115 utilizing cloud computing architecture. The cloud computing architecture provides resources required for computation present in the cloud network. The cloud network may be regarded as a network including multiple resources required for computing various tasks. Examples of resources include, but are not limited to, one or more processors, operating systems, display devices, one or more storage devices and the like. The users may request a task, for example, word processing, to the cloud service provider 110. The cloud service provider 110 communicates with the cloud network to initiate a virtual machine. The virtual machine includes resources such as hardware and software components required for processing the task. Upon processing, the result is displayed on a display device of the user.

Cloud computing architecture includes several virtual machines for providing multiple services to one or more users simultaneously. The cloud service provider 110 provides cloud computing architecture that is scalable. Further, the cloud service provider 110 performs billing based on one or more factors. Examples of the one or more factors include, but not limited to, trend, resource usage and utilization of cloud services during peak or off-peak hours and deployment speed.

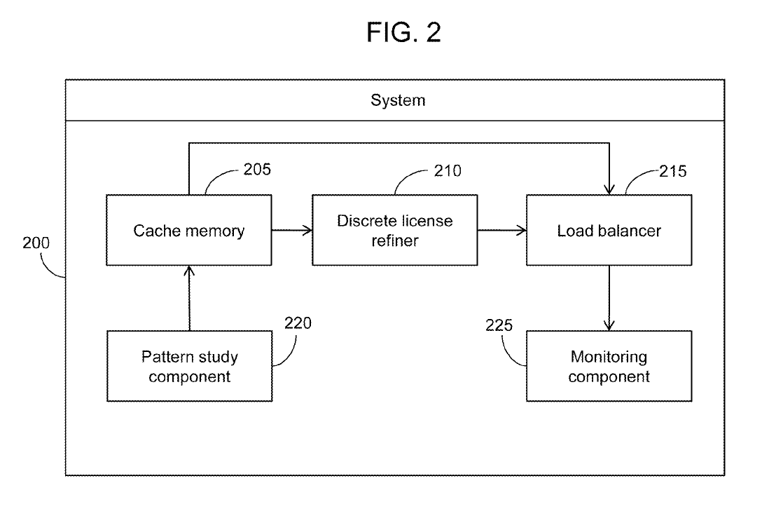

A system for providing an enhanced application centric cloud management is described in detail in FIG. 2.

FIG. 2 is a block diagram of a system 200 for an enhanced application centric cloud management in accordance with an exemplary embodiment. The system 200 includes a cache memory 205, a discrete license refiner 210, a load balancer 215, a pattern study component 220 and a monitoring component 225.

The cache memory 205 further comprises cache data. The cache data includes data associated with cloud applications that are most frequently used by a user. Further, the cache data also includes cloud applications recently utilized by the user. The cache data is stored in the cache memory 205. The cache memory 205 is utilized to obtain a user behavior. Further, the cache memory 205 is utilized to load the cache data when the user logs-in into the cloud application in future and obtains a virtual machine. The cache memory 205 is also utilized to identify an area of interest of the user. In one example, the user utilizes a word processing application. The word processing application includes multiple features such as font, paragraph and the like. Software codes execute each of the multiple features in a virtual machine. The cache memory 205 readily stores the software codes that the user may need when the user logs into the word processing application in a future operation, and hence enables quick loading. Further, the cache memory 205 reloads the software codes into the virtual machine.

The discrete license refiner 210 refines a license of the user. The discrete license refiner 210 is utilized for a resource pricing.

The resource pricing may be regarded as an amount charged by a cloud service provider for one or more sub-applications included within the cloud application utilized by the user. The discrete license refiner 210 enables the user to select the one or more sub-applications included within the cloud application. A component selector specifies the one or more sub-applications. Further, the component selector may also analyze the user behavior to identify the one or more sub-applications. The one or more sub-applications may be utilized by the user frequently. In one example, if the user utilizes sub-applications such as the paragraph and the font in the word processing application, then the discrete license refiner 210 refines the license of the user to provide a refined license. The refined license enables the user to utilize the paragraph and the font included within the word processing application. Further, the refined license enables resource pricing allowing the user to pay for the sub-applications such as the paragraph and the font and not for the word processing application altogether.

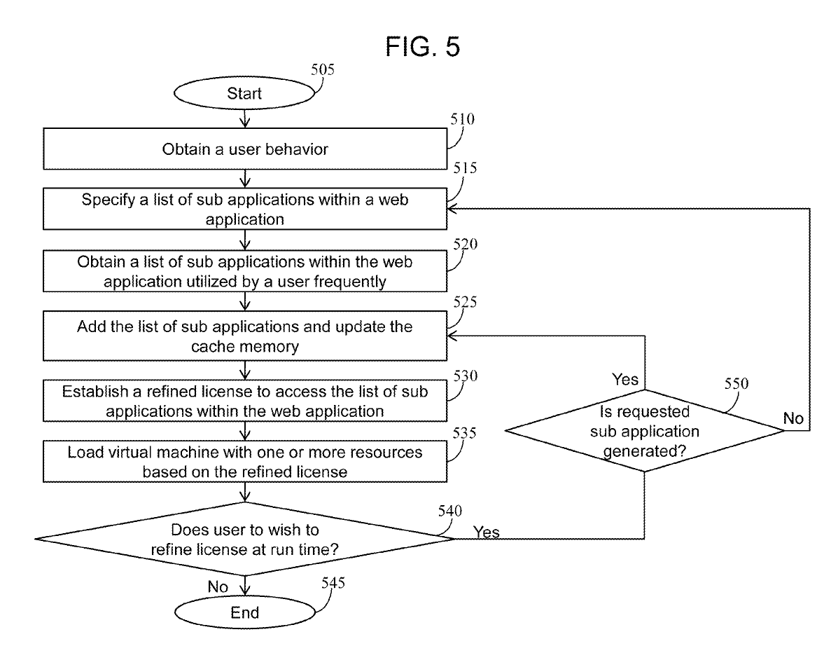

Furthermore, the discrete license refiner 210 enables the cloud service provider to build virtual machines with less over-head since sub-applications included within the cloud application that are not utilized by the user are eliminated. The method utilized by the discrete license refiner 210 for refining the license of the user is explained in detail in conjunction with FIG. 5.

The load balancer 215 maintains one or more resources. The one or more resources maintained by the load balancer 215 enables the user to perform computation of frequently utilized cloud applications. The load balancer 215 utilizes the user behavior to maintain the one or more resources and hence maintains resources that are required by the user for future use. Further, the load balancer 215 obtains a lock for the one or more resources. The lock enables the user to utilize the resources for a specified period of time.

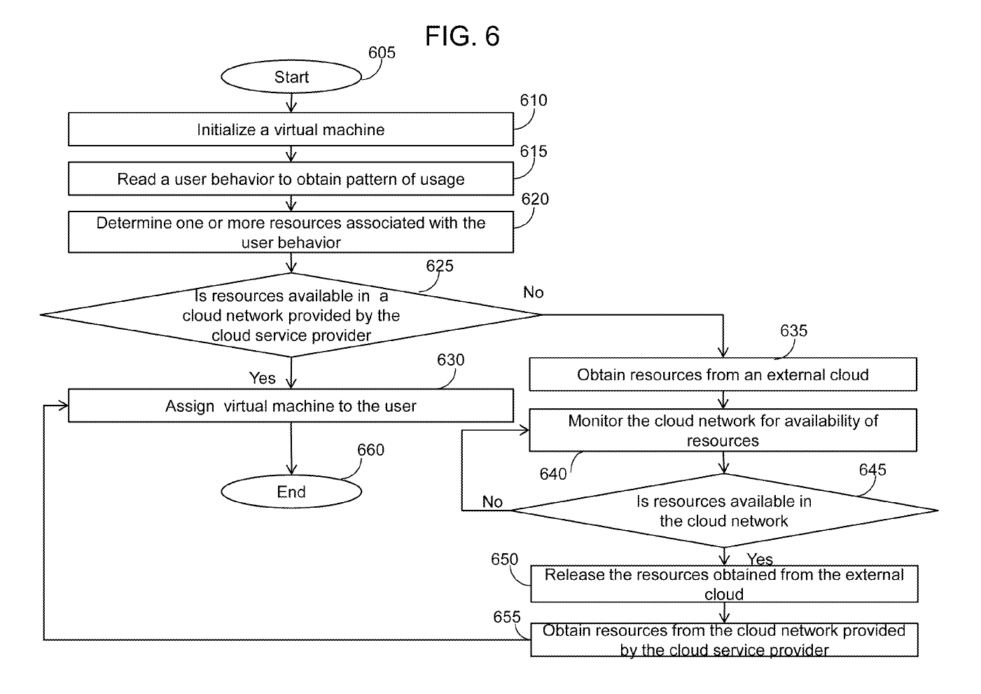

Furthermore, during initialization of the virtual machine, the load balancer 215 enables the cloud service provider to acquire the resources from an external cloud when the resources required for computation of the applications are not available within the cloud network of the user. The process utilized by the load balancer 215 for maintaining the resources is explained in detail in conjunction with FIG. 6.

The pattern study component 220 identifies the user behavior. Identification is performed by storing the codes of one or more frequently utilized applications by the user. The pattern study component 220 stores a cloud application of interest of the user. Storing enables the cloud service provider to initialize the virtual machine to quickly compute the desired application of the user.

The monitoring component 225 enables the cloud service provider to monitor the availability of the resources when they are obtained from an external cloud network. Upon determining the availability of the resources in the cloud network, the monitoring component 225 returns the resources obtained to the external cloud. The method utilized by the monitoring component 225 for monitoring the resources is explained in detail in conjunction with FIG. 6

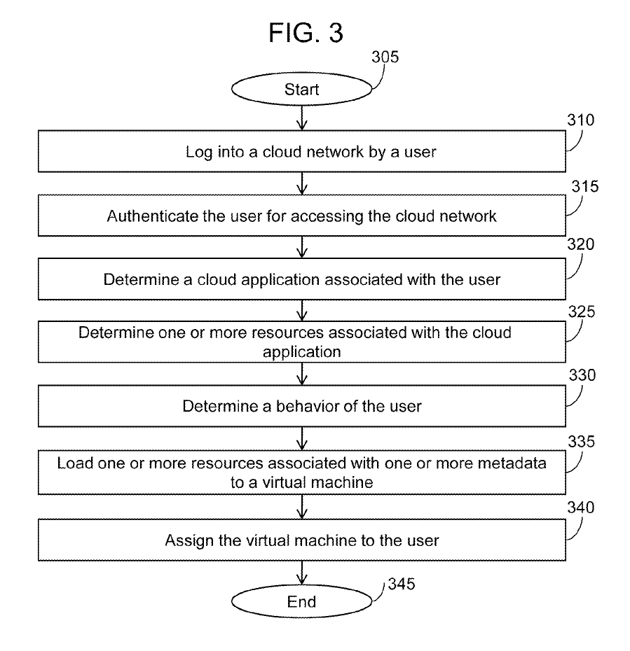

FIG. 3 is a flowchart illustrating a method for an enhanced application centric cloud management in accordance with an exemplary embodiment. The method starts at operation 305. At operation 310 a user logs into a cloud network. A username and a password are required for logging-in into the cloud network. Logging-in provides access to the cloud network. The user obtains the username and the password from a cloud service provider. The user enters the username and the password to obtain access to the cloud network.

At operation 315 the user is authenticated to access the cloud network. Authentication is performed by comparing the username and the password entered by the user with a list of usernames and corresponding passwords of a plurality of authenticated users of the cloud network. Upon authentication, the user is enabled to deploy a plurality of cloud applications. Further, the user is enabled to perform numerous tasks as desired.

At operation 320 a cloud application associated with the user is determined. In one example, the cloud application may include access to a Gmail account of the user. The user can configure the settings of the Gmail account. In one example, settings may include multiple options such as enabling saving draft messages, deleting sent messages and the like. Each of the options is enabled by deploying respective software codes. In another example, the user may wish to utilize a word processing application. The word processing application includes multiple sub-applications such as a font, a paragraph, page set-up, alignments and the like. Each of the sub-applications is deployed using respective software codes.

At operation 325 one or more resources associated with the cloud application is determined. The one or more resources include components such as hardware and software components required for deploying the cloud application. In one example, the resources include the software codes and the corresponding hardware for enabling the multiple options chosen by the user for configuring the settings of the Gmail account. In another example, the one or more resources including the resources for running the software codes for multiple sub-applications such as a font, a paragraph, page set-up, alignments and the like are determined.

At operation 330 a user behavior is determined. In one example, the user behavior indicates a cloud application that is frequently utilized by the user. In another example, the user behavior indicates cloud applications that were most recently utilized by the user. The user behavior is determined by storing the software codes of the cloud applications in a cache memory.

In another exemplary embodiment, the user behavior is determined by storing the resources including the hardware and software components required for storing at least one of the cloud applications frequently utilized by the user or the cloud applications most recently utilized by the user.

At operation 335 one or more resources associated with one or more metadata are loaded to a virtual machine. The one or more metadata includes information associated with at least one of the cloud applications frequently utilized by the user or the cloud applications most recently utilized by the user. Upon loading, the virtual machine includes all the necessary resources required for deploying a cloud application by the user and for performing the necessary tasks by the user.

The loading of resources to the virtual machine is based on a refined license of the user. The refined license allows access to the cloud applications chosen by the user. Further, the refined license allows access to the sub-application within the cloud applications that are frequently utilized by the user. Hence, the overhead of the virtual machine is reduced since resources for deploying only chosen cloud applications or the sub-applications within the cloud application is loaded.

At operation 340 the virtual machine loaded with the necessary resources are assigned to the user. The virtual machine includes the necessary hardware and software components required by the user for performing various tasks as desired. Further, the virtual machine includes the hardware and software components required for deploying sub-applications within the cloud application as specified in the refined license. Furthermore, the refined license enables the user to pay for the chosen sub-applications and not for the complete cloud application. The method stops at operation 345.

Meanwhile, the operations illustrated in FIG. 3 may be performed by a controller (not shown) such as a CPU and a processor.

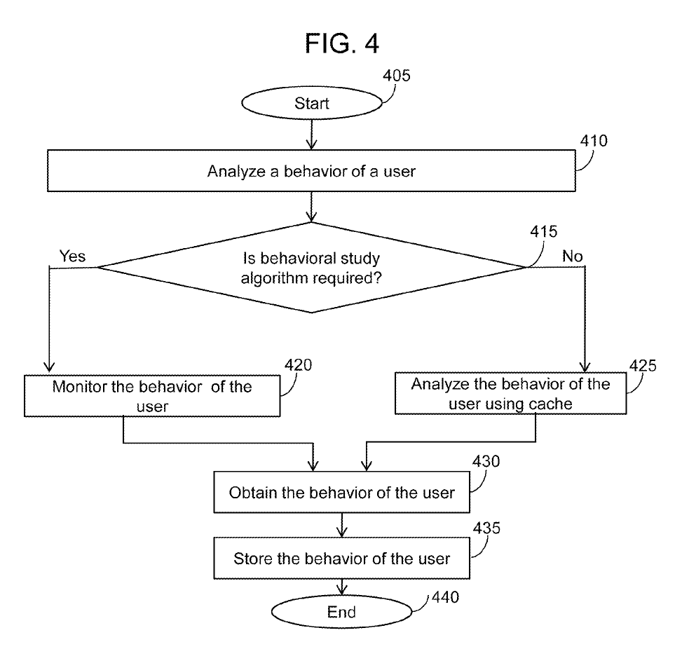

FIG. 4 is a flowchart illustrating a method for determining a user behavior in accordance with an exemplary embodiment. The method starts at operation 405. At operation 410 a behavior of a user is analyzed. Analysis is performed by identifying the one or more resources utilized by the user to deploy cloud applications. Analysis is also performed by determining the hardware and software components most frequently utilized by the user for performing various tasks.

At operation 415, it is analyzed to determine if a behavioral study algorithm is required for determining the behavior of the user. One or more behavioral study algorithms may be utilized for determining the behavior of the user. The behavioral study algorithm identifies the behavior of the user by storing frequently utilized hardware and software components. If the behavioral study algorithm is required then the operation 415 branches to operation 420 else the operation 415 branches to operation 425 where cloud management server identifies the user behavior using cache data analysis.

At operation 420 the behavior of the user is monitored. Monitoring includes identifying cloud applications frequently utilized by the user. Monitoring also includes identifying the most recent cloud applications utilized by the user. Further, monitoring includes identifying an area of interest of the user. In one example, if the user is utilizing only a font application within the word processing application, then the area of interest is considered to be the font application. Furthermore, monitoring includes identifying one or more resources associated with the area of interest of the user.

At operation 425 the behavior of the user is analyzed utilizing the cache data. Analysis includes identifying cloud applications frequently utilized by the user. Analysis further includes identifying cloud applications most recently utilized by the user. Further, the one or more resources associated with the frequently utilized cloud applications, the most recent cloud applications and the area of interest of the user are identified.

In an exemplary embodiment, an application centric server also analyzes the behavior of the user.

At operation 430 the behavior of the user is obtained. The behavior of the user is obtained from monitoring as described in operation 420. Further, the behavior of the user is obtained from analyzing as described in operation 425.

At operation 435 the behavior of the user obtained is stored in the cache memory. The cache memory stores cache data dynamically. The cache data includes resources associated with the interest of the user. Further, the cache data also includes resources associated with cloud applications most frequently utilized by the user. The cache data loads the resources onto a virtual machine quickly. Further, the cache data reduces overhead of the virtual machine since it includes resources associated with at least one of the frequently utilized cloud application and the resources associated with the interest of the user. The method ends at operation 440.

FIG. 5 is a flowchart illustrating a method for providing license refinement for cloud resources in accordance with an exemplary embodiment. The method starts at operation 505. At operation 510 a user behavior is obtained. The user behavior is obtained as described in FIG. 4.

The user behavior, in one example, includes sub-applications within a cloud application that is frequently utilized by the user, the cloud application of interest to the user and the like.

At operation 515 a list of sub-applications within the cloud application is specified by the user. In one example, a word processing application includes a plurality of sub-applications such as font, paragraph, alignment and the like. The user may utilize the font and the paragraph application frequently. Hence, the user can specify the font and paragraph in the list of sub-applications.

At operation 520 the list of sub-applications within the cloud application specified by the user is obtained. The user may select the sub-applications within the cloud application and submit the specified list to a cloud service provider.

At operation 525 the list of sub-applications within the cloud application that are frequently utilized by the user are added to the cache memory. The user may further add or delete sub-applications and update the cache memory. The cache memory stores resources required for deploying the sub-applications specified by the user.

At operation 530 a refined license is established. The refined license allows the user to access the sub-applications specified in the list. The refined license enables the user to pay for the specified list of sub-applications and not the complete cloud application.

At operation 535 one or more resources for enabling the sub-applications specified in the list is loaded onto a virtual machine. The virtual machine enables the user to perform a plurality of tasks as desired. The virtual machine loaded with the one or more resources includes less overhead and hence can be made available to the user quickly. The virtual machine includes less overhead since only resources associated with the specified list is aggregated and loaded and not resources associated with the complete cloud application. Further, the virtual machine loaded with one or more resources for enabling the sub-applications is provided to the user at runtime.

At operation 540 an analysis is performed to identify if the user wishes to refine the license at runtime. Refining includes at least one of adding or deleting the sub-application from the list of sub-applications specified for license refinement. If the user wishes to refine the license at runtime then operation 540 branches to operation 550 else operation 540 branches to operation 545. Further, if the user wishes to add a sub-application to the list then the user is required to specify the sub-application to be added.

At operation 550 it is determined if the sub-application the user wishes to add during run time is generated. If the sub-application is generated then the generated sub-application is added to the list and the cache memory is further updated as described in operation 525 else the user is required to specify the list of sub-applications that include the sub-applications to be added during run time as shown in operation 515. The method ends at operation 545.

FIG. 6 is a flowchart illustrating a method for obtaining load balancing for cloud resources in accordance with an exemplary embodiment. The method starts at operation 605. At operation 610 a virtual machine is initialized. A cloud service provider initializes the virtual machine to allow a user to perform one or more tasks as desired. Further, the user may deploy one or more cloud applications utilizing the virtual machine assigned by the cloud service provider.

At operation 615 a user behavior is read to obtain a pattern of usage. The pattern of usage in one example includes resources most frequently utilized by the user. In another example, the pattern of usage also includes resources associated with an area of interest of the user. The user behavior is read from a cache memory. The user behavior is read to maintain the resources associated with the pattern of usage within a cloud network provided by the Internet service provider.

At operation 620 one or more resources associated with the user behavior is determined. The one or more resources may be regarded as one or more hardware and software components required for performing multiple tasks as desired by the user. The user may pose a request for obtaining the one or more resources.

At operation 625 it is determined if the one or more resources associated with the user behavior are available in the cloud network provided by the cloud service provider to the user. The cloud network includes resources such as a plurality of web/cloud servers, hardware and software components, a plurality of cloud applications and storage devices. If the one or more resources are available then operation 625 branches to operation 630, else operation 625 branches to operation 635.

At operation 630 a virtual machine is assigned to the user. The virtual machine is loaded with the one or more resources. The one or more resources are obtained from the cloud provided by the cloud service provider. The virtual machine enables the user to perform one or more tasks as desired.

At operation 635 the one or more resources are obtained from an external cloud since the resources are unavailable in the cloud network provided by the cloud service provider. A reserve resource server may also obtain the resources that are unavailable. The one or more resources may be obtained for a specified period of time. The cloud service provider posts a request to the external cloud for obtaining the resources.

At operation 640 the cloud network provided by the cloud service provider is monitored for the availability of resources. Monitoring includes determining the availability of the resources within the cloud network provided by the cloud service provider. A monitoring component may determine the availability of the resources within the cloud network.

At operation 645 it is determined if the resources associated with the pattern of usage are available within the cloud network provided by the cloud service provider. The monitoring component may determine the availability. If the resources are available within the cloud network provided by the cloud service provider then operation 645 branches to operation 650 else monitoring for the availability of the resources is continued as described in operation 640.

If the resources are available within the cloud network provided by the cloud service provider then at operation 650 the resources obtained from the external cloud are released. The resources are released to save cost of borrowing from the external cloud.

At operation 655 the resources present in the cloud network provided by the cloud service provider is obtained. The resources obtained are loaded to the virtual machine and are further assigned to the user as described in operation 630. The method ends at operation 660.

Advantageously the exemplary embodiments record the user behavior such as the most frequently utilized cloud application and the most recent data processed by the user. The exemplary embodiments utilize the recorded information to obtain resources associated with the user behavior thereby aiding the user to quickly obtain subsequent quick log-ins. The exemplary embodiments also allow the cloud service provider to maintain resources based on the interest of the user.

The exemplary embodiments further provide resource pricing thereby enabling the user to pay for the resources associated with the user's interest, without having to pay for the entire cloud application. The exemplary embodiments reduce the cost of licenses provided to the user. Further, the exemplary embodiments enable the creation of licenses in accordance with the business needs of the cloud service provider.

The exemplary embodiments enable the cloud service provider to obtain resources from an external cloud in case of non-availability of resources in the cloud network provided by the cloud service provider. The exemplary embodiments also provide the advantage of monitoring the resources for availability. Upon the availability of resources, the resources obtained from the external cloud are returned and thereby enable the-cloud service provider to pay reduced service charges for obtaining the resources. The exemplary embodiments also provide increased system efficiency.

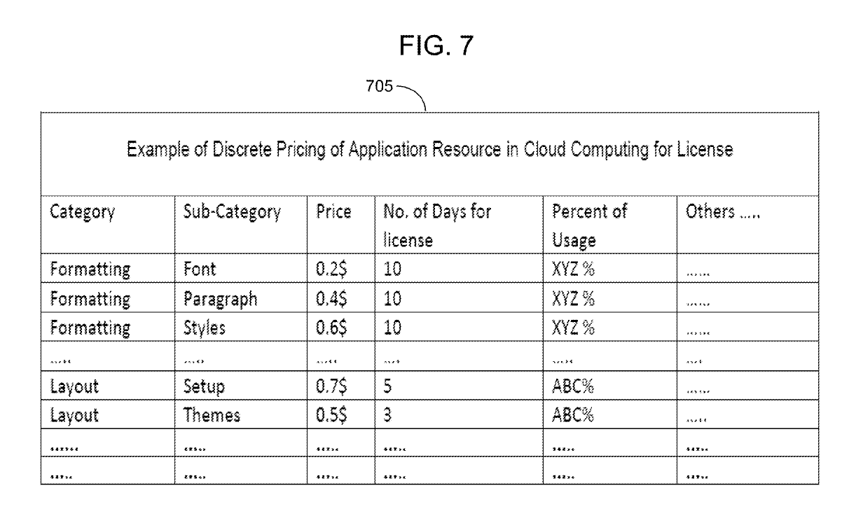

FIG. 7 is an exemplary illustration for providing discrete pricing of cloud applications in accordance with an exemplary embodiment. The table 705 includes columns such as category, sub-category, price, number of days for license and percent of usage.

The category may be regarded as a cloud application. The sub-category may be regarded as a sub-application within the cloud application. Price indicates the cost of the sub-application within the cloud application. The discrete license provided in the current example includes providing access to sub-applications within the cloud application. In the current example, the “formatting” is the cloud application and “font” is regarded as the sub-application within the “formatting” cloud application. The 0.2$ price indicates the cost required for utilizing the font application within the formatting application.

Further, the font application costing 0.2$ is validated for a period of 10 days based on the number of days for usage of the license. The percent of usage indicates the resource utilization factor. The license further provides access to the sub-application “paragraph” within the cloud application “formatting”. The cloud service provider charges 0.4$ for utilizing the sub-application “paragraph” for a period of 10 days. The discrete license further enables the user to alter the validity period.

The discrete license further provides access to the sub-application “style” within the cloud application “formatting”. The table 705 indicates the cloud service provider charging 0.6$ for utilizing the sub-application “style” within the cloud application “formatting” for a period of 10 days. The discrete license also provides access to the sub-application “set-up” within the cloud application “layout”. The table 705 indicates the cloud service provider charging 0.7$ for utilizing the sub-application “style” within the cloud application “formatting” for a period of 5 days. Further, the discrete license provides access to the sub-application “themes” within the cloud application “layout”. The table 705 indicates the cloud service provider charging 0.5$ for utilizing the sub-application “themes” within the cloud application “formatting” for a period of 3 days. The cloud service provider may introduce varying costs at varying periods for enabling the users to access a sub-application within a cloud application based on business requirements.

What is claimed is:

1. A method for managing a cloud, the method comprising:
authenticating a user to access a cloud network;
determining a user behavior of the authenticated user using one or more metadata stored in a cache memory;
loading resources related to the user behavior to a virtual machine; and
allocating the virtual machine to the authenticated user.

2. The method as claimed in claim 1, wherein the determining comprises:
determining a cloud application associated with the authenticated user;
determining one or more resources related to the cloud application associated with the authenticated user; and
determining resources related to a user behavior from among the resources based on the one or more metadata stored in the cache memory.

3. The method as claimed in claim 2, wherein the one or more metadata comprises information related to at least one of a cloud application most frequently used by the authenticated user and a cloud application most recently used by the authenticated user.

4. The method as claimed in claim 2, wherein the user behavior is at least one of a pattern of usage, a setting, a service of interest, and the cloud application associated with the authenticated user.

5. The method as claimed in claim 2, further comprising:
classifying sub-components of the cloud application associated with the user; and
setting a refined license with respect to the classified sub-components,
wherein the loading loads resources related to the user behavior based on a license refined by the user with respect to the classified sub-components.

6. The method as claimed in claim 5, wherein the setting further comprises:
generating and displaying a user interface (UI) to set the refined license with respect to the sub-components.

7. The method as claimed in claim 1, further comprising:
determining whether the resources related to the user behavior are available in the cloud network; and
when the resources related to the user behavior are not available in the cloud network, obtaining the resources from an external cloud network.

8. A cloud management system, comprising:
a cache memory which stores one or more metadata; and
a controller which, when a user to access a cloud network is authenticated, determines a user behavior of the authenticated user using the cache memory, loads resources related to the user behavior to a virtual machine, and allocates a virtual machine to the authenticated user.

9. The system as claimed in claim 8, wherein the controller determines a cloud application associated with the authenticated user, determines one or more resources related to the cloud application associated with the authenticated user, and determines resources associated with a user behavior from among the resources using a cache memory storing one or more metadata.

10. The system as claimed in claim 9, wherein the one or more metadata comprises information related to at least one of a cloud application most frequently used by the authenticated user and a cloud application most recently used by the authenticated user.

11. The system as claimed in claim 9, wherein the user behavior is at least one of a pattern of usage, a setting, a service of interest, and the cloud application of the authenticated user.

12. The system as claimed in claim 9, further comprising:
a discrete license refiner which categorizes sub-components of a cloud application related to the user and sets a reference license with respect to the categorized the sub-components,
wherein the controller loads resources associated with the user behavior based on a refined license set by the discrete license refiner.

13. The system as claimed in claim 12, wherein the controller generates and displays a user interface (UI) to set a refined license with respect to the sub-components.

14. The system as claimed in claim 8, wherein the resources are at least one of a hardware component and a software component required to use a cloud application.

15. A method for managing a cloud, the method comprising:
authenticating a user to access a cloud network;
determining a cloud application associated with the user;
determining one or more resources associated with the cloud application;
determining a behavior associated with the user;
loading resources to a virtual machine based on the behavior associated with the user, and
assigning the virtual machine to the user.

16. The method of claim 15, wherein the user behavior is at least one of a cloud application that is frequently utilized by the user and a cloud application that was most recently utilized by the user.

17. The method of claim 15, wherein the user behavior comprises at least one of a pattern of usage, a setting, a service of interest, and the cloud application of the authenticated user.
